(19) United States
(12) Patent Application Publication
(10) Pub. No.: US 2019/0202074 A1
(43) Pub. Date: Jul. 4, 2019

(54) Knife with Replaceable Blade

(71) Applicant: Stanley Black & Decker, Inc., New Britain, CT (US)

(72) Inventors: Aliaksei Chernyshou, Farmington, CT (US); Thomas A. Pelletier, Wallingford, CT (US)

(21) Appl. No.: 15/860,270

(22) Filed: Jan. 2, 2018

(51) Int. Cl. B26B 5/00; B26B 11/00

(52) U.S. Cl. CPC B26B 5/005; B26B 11/00

(57) ABSTRACT

A knife includes a handle portion and a cutting head portion. The cutting head portion includes a lid portion and a base portion configured to receive a blade therebetween. The lid portion is coupled to the base portion by a hinge. Rotation of the lid portion relative to the base portion away from the base portion opens a space above the base portion through which the blade may lifted. A method of removing a blade from a knife includes rotating a lid portion relative to a base portion about a hinge coupling the lid portion to the base portion, further rotating the lid portion until a protrusion fixed to the lid portion extends through the base portion and lifts up on the blade to create a gap between the blade and the base portion, and grasping the blade at the gap to pull the blade away from the base portion.

### FIELD OF THE INVENTION

The present invention relates generally to knives, and in particular box, film, and tape splitting knives.

### BACKGROUND OF THE INVENTION

Store clerks, warehouse clerks, and others often are repeatedly manipulating boxes and other packages, including opening and unbundling the packages for removal or display of contents.

Among other things, the present application relates to improvements to utility knives facilitating opening of packaging material.

### SUMMARY OF THE INVENTION

According to an embodiment, a knife includes a handle portion and a cutting head portion. The cutting head portion includes a lid portion and a base portion configured to receive a utility knife blade therebetween. The lid portion is coupled to the base portion by a hinge. Rotation of the lid portion relative to the base portion away from the base portion opens a space above the base portion through which the utility knife blade may lifted.

According to another embodiment, a method of removing a blade from a knife includes rotating a lid portion relative to a base portion configured to receive a utility knife blade therein about a hinge coupling the lid portion to the base portion, further rotating the lid portion until a protrusion fixed to the lid portion extends through the base portion and lifts up on the blade to create a gap between the blade and the base portion, and grasping the blade at the gap to pull the blade away from the base portion.

The objects, features, and characteristics of the present invention, as well as the methods of operation and functions of the related elements of structure and the combination of parts and economies of manufacture, will become more apparent upon consideration of the following description with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only, and are not intended as a definition of the limits of the invention. In addition, it should be appreciated that structural features shown or described in any one embodiment herein can be used in other embodiments as well. As used herein, the singular form of “a”, “an”, and “the” include plural referents unless the context clearly dictates otherwise.

### BRIEF DESCRIPTION OF THE DRAWINGS

Features of knives in accordance with one or more embodiments are shown in the drawings, in which like reference numerals designate like elements. The drawings form part of this original disclosure in which:

FIG. 1 illustrates a top view of an embodiment of a knife of the present disclosure, having a handle portion with a cutting head portion received therein;

FIG. 2 illustrates a perspective view of the knife of FIG. 1, having a top portion of the handle portion removed to show an interior thereof;

FIG. 3 illustrates a perspective view of the knife of FIG. 1, showing the cutting head portion removed from the handle portion;

FIG. 4 illustrates a top view of an embodiment of the cutting head portion of the knife of FIG. 1;

FIG. 5 shows a side view of the cutting head portion of FIG. 4, with a lid portion pivoted relative to a base portion;

FIG. 6 shows a perspective view of the cutting head portion of FIG. 4, with the lid portion pivoted further away from the base portion than as FIG. 5, and with no blade received therein;

FIG. 7 shows a side view of the cutting head portion of FIG. 4, with the lid portion pivoted further away from the base portion than as FIGS. 5 and 6 causing a projection extending therefrom to lift upwards from the base portion; and

FIG. 8 shows a perspective view of the cutting head portion pivoted as shown in FIG. 7, however with a blade therein showing that rotation of the lid portion relative to the base portion causes the projection to lift the blade upwards from the base portion to simplify removal and replacement of the blade.

### DETAILED DESCRIPTION OF THE ILLUSTRATED EMBODIMENT(S)

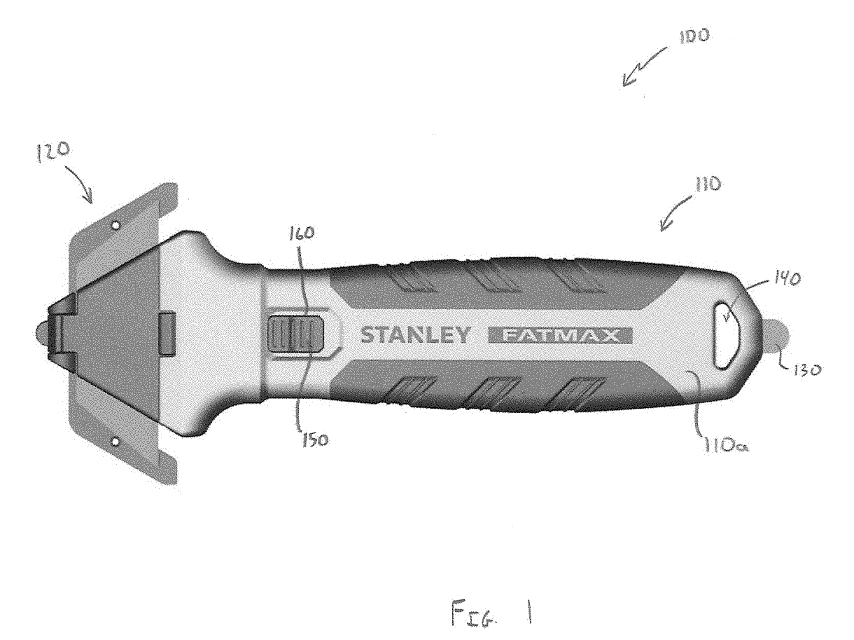

As shown in FIG. 1, in an embodiment a knife 100 (e.g., a fixed blade knife, safety knife, or a pull knife) includes a handle portion 110 and a cutting head portion 120 that may be partially selectively received in the handle portion 110. As shown, the handle portion 110 may include features such as a film splitter 130 which may provide an entry puncture in packaging material. In some embodiments, the handle portion 110 may also include a slot 140 which may be sized to receive a lanyard or a hook therein for storage of the knife 100.

As described in greater detail below, the cutting head portion 120 may include a retention feature 150 which may protrude into an aperture 160 in the handle portion 110 when the cutting head portion 120 is received in the handle portion 110, selectively securing the cutting head portion 120 to the handle portion 110.

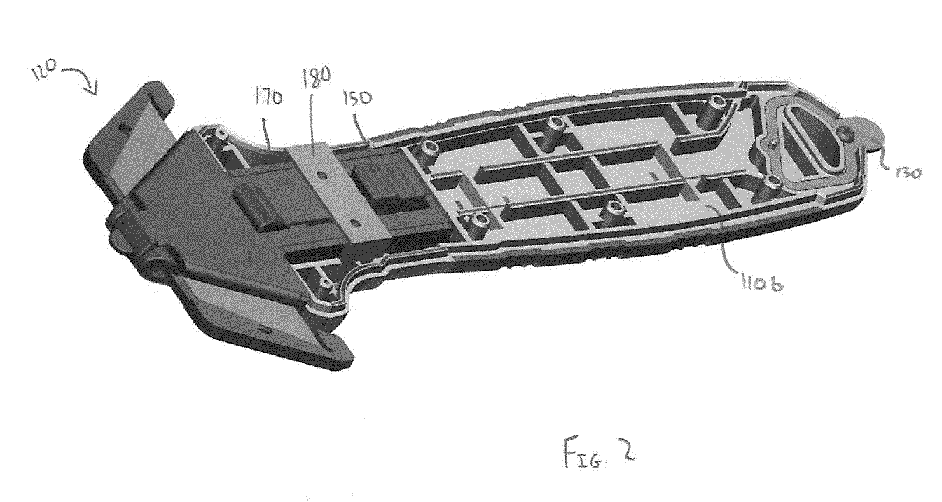

In some embodiments, the handle portion 110 may be formed through the assembly of a top portion 110a and a bottom portion 110b, together forming a cavity therebetween. As shown in FIG. 2, where the top portion 110a visible in FIG. 1 is removed so as to show the interior of the cavity and associated region of the bottom portion 110b, the cavity may be shaped to receive an engaging region 170 that includes the retention feature 150 of the cutting head portion 120 therein. As further shown, in some embodiments a brace 180 may be formed in the handle portion 110 (e.g., mounted to the bottom portion 110b and secured by the top portion 110a adjacent to the aperture 160) so as to assist in engaging with the retention feature 150 so as to prevent sliding removal of the cutting head portion 120 until the retention feature 150 is activated (e.g., by depressing a spring biased or otherwise resilient retention feature 150 into the handle portion 110 until it clears the brace 180). In some embodiments, where the handle portion 110 may be formed from plastic or other relatively soft material, the brace 180 may be formed from metal or some other relatively hard material, so as to limit wear to the handle portion 110 when the head portion 120 is removed and reinserted over time.

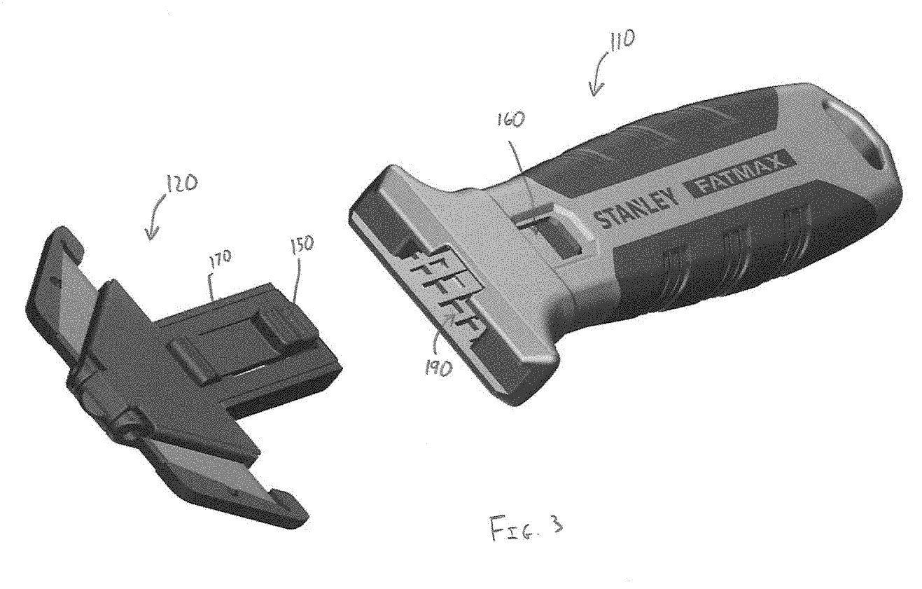

As shown in FIG. 3, when the retention feature 150 of the cutting head portion 120 in the illustrated embodiment is depressed, the cutting head portion 120 may be slid out of the cavity formed in handle portion 110 (e.g., by sliding the engaging region 170 out of a forward opening 190 therein). Once separated, it may be appreciated that the retention feature 150 may return to a protruding configuration. Accordingly, returning the cutting head portion 120 into the handle portion 110 may comprise depressing the retention feature 150 inward so as to slide the engaging region 170 into the forward opening 190, until the retention feature again clears the brace 180 and returns to its protruding configuration through the aperture 160.

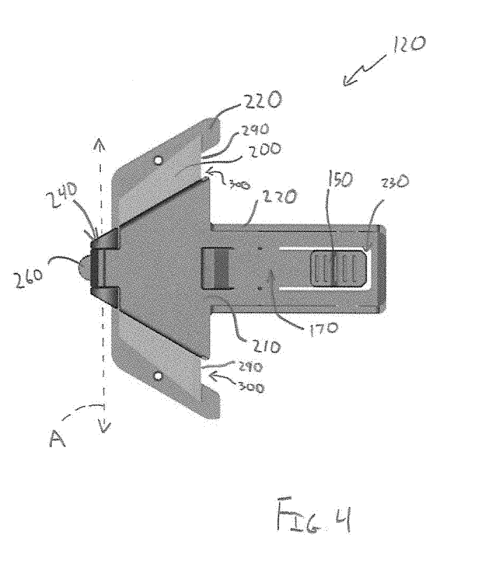

Turning specifically to the cutting head portion 120, as shown in the embodiment of FIGS. 4-8, selective retention of a blade 200 therein may be appreciated. As shown, the cutting head portion 120 may include a lid portion 210 that may be pivotable relative to a base portion 220. As shown, the retention feature 150 may be formed on the lid portion 210, and may be depressible into an aperture below the retention feature 150 (e.g., formed in a gap between the lid portion 210 and the base portion 220 below the retention feature 150). In some embodiments, an aperture 230 may extend through the base portion 220 below the retention feature 150 on the lid portion 210, such that depression of the retention feature 150 may cause the retention feature 150 to enter the aperture 230 so as to bring the retention feature 150 below the brace 180 or otherwise out of the aperture 160 on the handle portion 110.

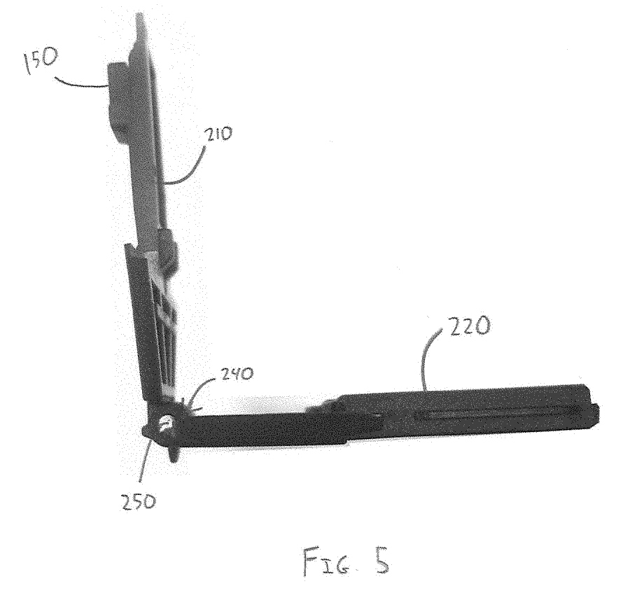

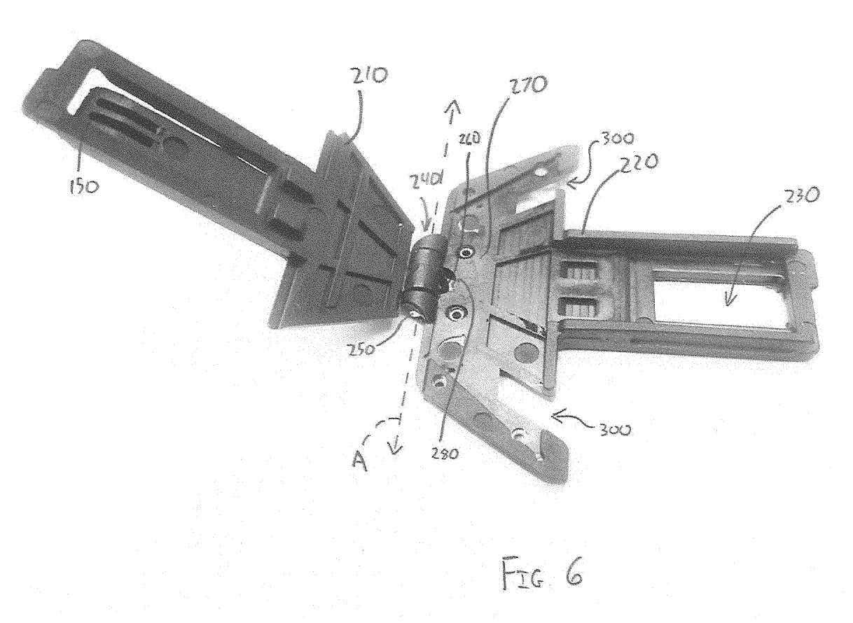

As shown in greater detail in FIG. 5, in an embodiment the lid portion 210 may be coupled to the base portion 220 at a hinge 240 which may define an axis of rotation A. In an embodiment, hinge portions of each of the lid portion 210 and the base portion 220 may rotate about a hinge pin 250 inserted through and extending through each at the axis of rotation A. Accordingly, by lifting up on the lid portion 210 to rotate the lid portion 210 relative to the base portion 220 via the hinge 240, the cutting head portion 120 may be moved from a closed position as seen in FIG. 4 (wherein the lid portion may trap the blade 200 between the lid portion 210 and the base portion 220) to an open position as seen in FIGS. 5 and 6, where the blade 200 would no longer be enclosed between the lid portion 210 and the base portion 220.

The embodiment of FIGS. 4-8 further shows that the lid portion 210 may include a protrusion 260 fixed thereto, and rotatable about the hinge 240 therewith. In some embodiments, the protrusion 260 may extend forward of the remainder of the cutting head portion 120, and may serve as a film splitter similar to the film splitter 130.

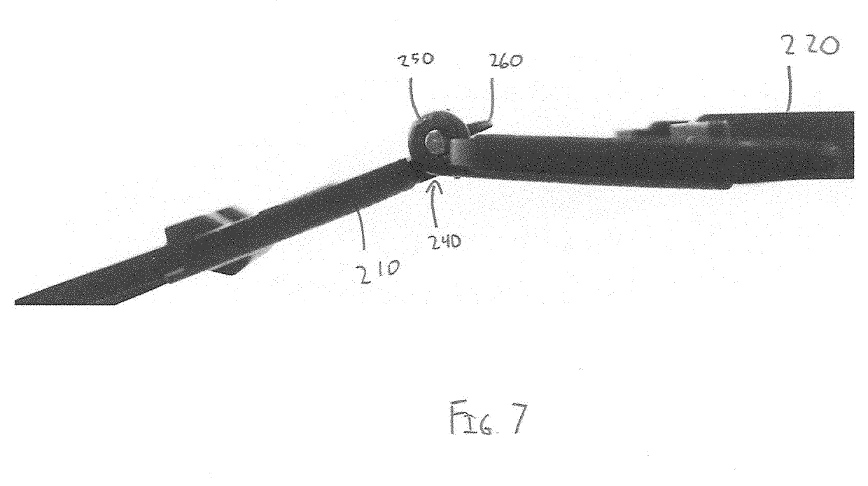

As shown in FIG. 6, in an embodiment the base portion 220 may include therein a blade recess 270 which may be shaped to receive a standard trapezoidal utility knife blade. In an embodiment, the base portion 220 may further include an aperture 280 adjacent to the hinge 240, which may extend into the blade recess 270. It may therefore be appreciated, as shown more clearly in FIG. 7, that rotation of the lid portion 210 relative to the base portion 220 may cause the protrusion 260 to rotate through the aperture 280, and thus rise upwards out of the blade recess 270.

As noted above, in an embodiment the blade recess 270 may be shaped to receive a standard trapezoidal utility knife blade. For example, in the illustrated embodiment where the knife 100 is a pull knife, the blade recess 270 may itself have a trapezoidal configuration, so as to guide insertion of the blade 200 therein so that a cutting edge 290 of the blade 200 may be oriented to face gaps 300 formed in the cutting head portion 120 positioned so that by a user pulling the handle portion 110 a substrate therein to be cut may be received in one of the gaps 300.

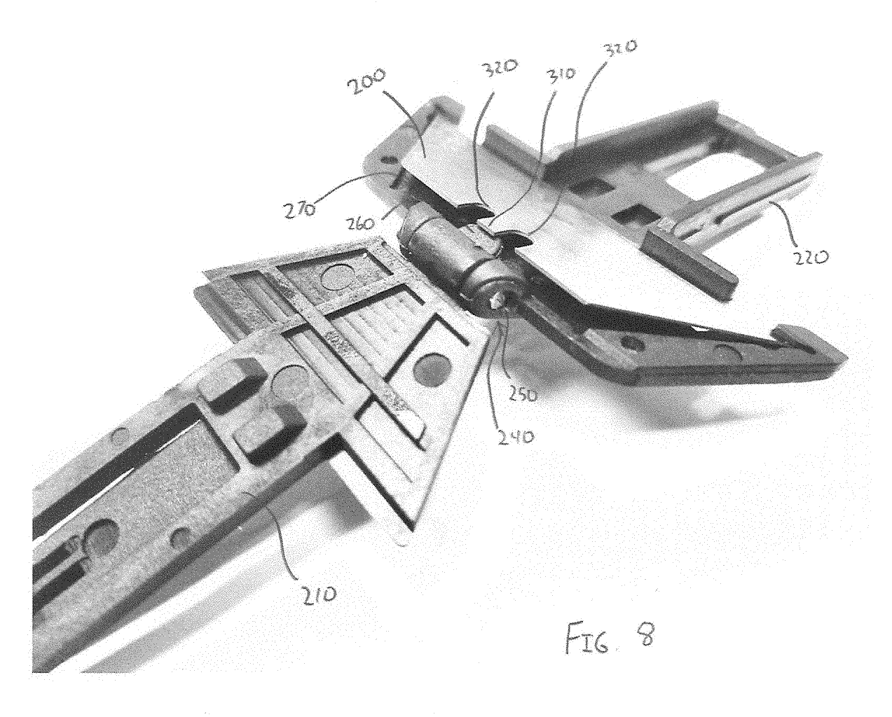

Accordingly, as shown in FIG. 8, when a standard trapezoidal utility knife blade 200 is in the blade recess 270, and the lid portion 210 is sufficiently rotated relative to the base portion 220 so that the protrusion 260 rotates through the aperture 280 and rises out of the blade recess 270, the protrusion 260 may partially lift the blade 200 out of the blade recess 270, facilitating a user grasping the raised edge of the blade 200 for removal and replacement of the blade 200 with another utility knife blade. As shown, in an embodiment the protrusion 260 may engage with a center tab 310 on the blade 200, which is commonly located between notches 320 which allow for rotation of a blade in a standard utility knife to utilize a fresh side of the cutting edge 290 of the trapezoidal blade 200. It may be appreciated that in other embodiments the protrusion 260 (or multiple protrusions 260, or other similarly configured members) may rotate to lift the blade at other portions of the blade 200 (e.g., on opposing sides thereof, or from a midpoint on the blade 200)

In various embodiments, the knives and blades described herein may be formed of metal, plastic, ceramic, or any other appropriate material. Similarly, the cutting heads 120 may be configured in a variety of configurations, including double sided as shown in the illustrated embodiment, or single sided wherein only one gap 300 is provided, such that the blade may be rotated to expose a previously obscured portion of the cutting edge 290.

It may be appreciated that the components described herein may be of different constructions or configurations, including but not limited to one or more being comprised of different material choices. For example, the components described herein may each be constructed from a variety of materials, including but not limited to one or more of fabrics, plastics, metals, rubbers, elastomers, or any other appropriate material choice. For example, in an embodiment one or more of the components (e.g., blades) may be formed of aluminum (e.g., machined aluminum), iron (e.g., steel), ceramic, or any other appropriate material. Similarly, the handle portion 110 and cutting head portion 120 may be formed from molded plastic, metal, or combinations thereof (e.g., plastic with metal supports, such as the brace 180 or fasteners coupling portions tougher. In some embodiments, the material choices may differ from component to component. In various embodiments, some components may be integrally formed together, while other components may be assembled by any appropriate mechanism, including but not limited to fastened, welded, glued, snap-fit, or other appropriate securements.

Although aspects of the invention have been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the exemplary disclosed embodiments. For example, it is to be understood that the present invention contemplates that, to the extent possible, one or more features of any embodiment can be combined with one or more features of any other embodiment.

What is claimed is:

1. A knife comprising:
a handle portion; and
a cutting head portion;
wherein the cutting head portion comprises a lid portion and a base portion configured to receive a utility knife blade therebetween;
wherein the lid portion is coupled to the base portion by a hinge; and
wherein rotation of the lid portion relative to the base portion away from the base portion opens a space above the base portion through which the utility knife blade may lifted.

2. The knife of claim 1, wherein the lid portion comprises a protrusion configured to rotate with the lid portion relative to the base portion.

3. The knife of claim 2, wherein the protrusion is film splitter.

4. The knife of claim 2, wherein the base portion comprises an aperture through which the protrusion rotates as the lid portion is rotated from a closed position configured to receive the utility knife blade between the lid portion and the base portion, to an open position forming the open space above the base portion through which the utility knife blade may be lifted, such that rotation of the lid portion causes the protrusion to lift the utility knife blade up from the base portion.

5. The knife of claim 1, wherein the base portion comprises a blade recess shaped to receive a utility knife blade.

6. The knife of claim 5, wherein the blade recess is generally trapezoidal.

7. The knife of claim 1, wherein the cutting head portion comprises a gap shaped to expose a portion of a cutting edge of the utility knife blade.

8. The knife of claim 7, wherein the cutting head portion is double sided and further comprises a second gap opposite the gap, wherein the gap and the second gap expose opposing portions of the cutting edge of the utility knife blade.

9. The knife of claim 1, wherein the cutting head portion is selectively removable from the handle portion.

10. The knife of claim 9, further comprising a retention feature on the cutting head portion that is selectively received in an aperture on the handle portion.

11. The knife of claim 10, wherein depressing the retention feature causes the cutting head portion to disengage from the aperture, so that the cutting head portion may be slid out of and separated from the handle portion.

12. A method of removing a blade from a knife comprising:
rotating a lid portion relative to a base portion configured to receive a utility knife blade therein about a hinge coupling the lid portion to the base portion;
further rotating the lid portion until a protrusion fixed to the lid portion extends through the base portion and lifts up on the blade to create a gap between the blade and the base portion; and
grasping the blade at the gap to pull the blade away from the base portion.

13. The method of claim 12, further comprising, prior to said rotating the lid portion:
pressing a retention feature coupled to the lid portion into a handle portion of the knife;
sliding the lid portion and the base portion together away from the handle portion to separate the lid portion and base portion together from the handle portion.
